(19) United States
(12) Patent Application Publication
(10) Pub. No.: US 2012/0286933 A1
(43) Pub. Date: Nov. 15, 2012

(54) FIRST RESPONDER TEAM TRACKING SYSTEM AND METHOD

(75) Inventor: Vic Hsiao, Mission Viejo, CA (US)

(73) Assignee: KNOWLEDGE ACCESS, INC.

(21) Appl. No.: 13/106,753

(22) Filed: May 12, 2011

(51) Int. Cl. G06K 7/01; G08B 5/22

(52) U.S. Cl. 340/8.1; 340/10.5

(57) ABSTRACT

A position tracking system for responders to an emergency is presented. The position tracking system includes a unique electronic tag attached to each responder and comprising a transceiver, the unique electronic tag configured to receive information and transmit a unique identifier via the transceiver, at least one moveable base station, and a command post comprising the command post transceiver configured to send and receive information.

### BACKGROUND OF THE INVENTION

1. Field of the Invention

The present invention relates to a position tracking system, a method for rapid deployment and initialization of a position tracking system, and more particularly, to the use of a rapidly deployed position tracking system with a Responder team operation.

2. Discussion of the Related Art

Responders to an emergency or a disaster may include firefighters, policemen, medical technicians, doctors, or other such personnel. Hereinafter, the term “Responder” will refer to personnel which may respond to a scene of an incident.

In an indoor incident, Responders have to deal with a number of unknown situations, such as building structure, disaster type, disaster intensity, number of Responders needed, resources needed, or other such situations. In order to obtain maximum effectiveness, the Commander of an incident scene requires the accurate reporting of the status of all resources, including personnel.

Generally, for status reporting, Responders are provided with a talk-radio to communicate with other personnel or a command post. The talk-radios may not be effective at all times due to, for example, structural blockages, debris, electronic interference, or physical interference. In the event of a fire, a Responder may be exposed to, such things as, extreme heat, water, power lines, or hazardous materials. Under such an environment, it is very easy for a Responder to be set apart from his peers or to lose his sense of direction.

With limited resources at hand, a Responder may not have the time required to report his location when support is needed. Therefore, a location tracking system would be beneficial to aide a support team in determining the location of a Responder.

Numerous systems exist to provide tracking for Responders. These systems include, for example, “First Responder Positioning Apparatus” from Dennis Lee Workman, “RF/Acoustic Person Locator System” from Steve D. Huseth of Honeywell International Inc., and “Precision Location Methods and Systems” from David Cyganski of Worcester Polytechnic Institute.

The aforementioned tracking systems typically include a navigation system, such as Global Positioning System (GPS), multiple fixed reference stations attached to the incident scene, multiple fixed reference stations installed on vehicles or public infrastructure, and complex electronic circuitry carried by Responders. The advent of the GPS system has made it possible for a geographic location to be determined within a sub-meter.

While GPS allows for a Responder's position to be rapidly and accurately determined, GPS requires a high performance antenna. Carrying a high performance antenna is an additional burden for a Responder. Moreover, without a high performance antenna, a GPS signal is not always available or reliable when a Responder is indoors.

Triangulation algorithms and multi-lateration algorithms for determining a position of an object have been well developed and widely employed. These algorithms use a known position of multiple reference points and utilize the distance from the reference point to the object in order to triangulate the object's position. Triangulation algorithms require at least two reference points. For a more accurate triangulation in a three-dimensional (3D) space, the reference points should be positioned around the object and be as far apart as possible.

Triangulation algorithms or multi-lateration algorithms are typically used in ranging systems requiring multiple fixed reference stations. In many configurations, ranging systems requiring multiple fixed reference stations attached to the incident scene are not useful or effective for an indoor incident. Specifically, the time required to install and initialize the fixed reference stations is not suitable for a rapid deployment environment such as an emergency or disaster. Moreover, fixed reference stations may not be installed to form an optimal topology to produce the best results for a Responder's position.

For the reasons mentioned above, multiple fixed reference stations installed on vehicles or public infrastructures are also not useful or effective. In addition, the dynamics of an emergency or disaster may cause the installed fixed reference stations to be damaged or rendered ineffective as a result of structural damage from the incident.

The damage to the fixed reference stations or the structure would directly impact the effectiveness of the installed system. Furthermore, it is extremely difficult and impractical, if not impossible, to install the required reference points for an indoor incident, such as when the incident involves as a high rise building with numerous floors.

Additionally, tracking systems requiring complex electronic circuitry are impractical. Systems with complex electronic circuitry have higher electric power requirements, generate more heat, are heavier in weight, and larger in size. Responders may be burdened by the increased weight and size of the tracking system equipment.

Thus, it is desirable to provide a reference point subsystem that can be easily transported to an incident scene and positioned at a desired location to achieve an optimal topology. Additionally, the reference point should operate reliably and effectively in all weather conditions and should be physically independent of other components in the system.

Furthermore, a need exists for a Responder tracking system including a reference point subsystem that can be quickly, reliably, and effectively deployed, in an indoor or outdoor environment. The Responder tracking system should also include a Responder personnel electronic identifier tag that can be easily worn by a Responder and a command post subsystem that can derive a position of each individual Responder, create a three-dimensional (3D) Responder position map, and display the 3D Responder position map for tracking the Responder team operation.

Accordingly, the proposed position tracking system accurately and quickly provides the status and condition of all resources, including personnel. The proposed position tracking system also facilitates effective Responder team operation and further facilitates support to a Responder as needed at an incident scene.

### SUMMARY

Features and advantages of the invention will be set forth in the description which follows. The objectives and other advantages of the invention will be realized and attained by the structure particularly pointed out in the written description and claims hereof as well as the appended drawings.

According to one embodiment, a position tracking system for responders to an emergency is presented. The position tracking system includes a unique electronic tag attached to each responder and comprising a transceiver, the unique electronic tag configured to receive information and transmit a unique identifier via the transceiver, at least one moveable base station, and a command post comprising the command post transceiver configured to send and receive information, wherein the at least one moveable base station comprises a first antenna configured to communicate with the transceiver of the unique electronic tag, a second antenna configured to communicate with the command post transceiver, a navigation unit for determining a current position of the at least one moveable base station, a radio-frequency identification (RFID) reader configured to decode information received from the unique electronic tag, and a processor configured to control the navigation unit and the RFID reader.

According to one feature, the at least one moveable base station further includes a housing unit configured to house the first antenna, the second antenna, the navigation unit, the RFID reader, and the processor, an inflatable bladder attached to the housing unit and configured to inflate and lift the housing unit to a desired height, a cord attached to the housing unit and configured to adjust the height at which the inflatable bladder is deployed, and a storage cart configured to store and to transport the housing unit, the inflatable bladder, and the cord to a desired location.

According to another feature, the command post further includes a central processing unit, a memory unit comprising a base station message database and a responder location database, a location processor configured to determine the location of a responder using information received at the at least one moveable base station and to store the determined location of the responder in a responder data record associated with the responder location database, a physical condition monitoring processor, an electronic identifier position map processor for generating a three-dimensional (3D) position map of a responder using the responder data record associated with the responder location database, a user interface for displaying the 3D position map, and a communication processor for controlling the receiving and transmitting of messages via the command post transceiver.

According to yet another feature, the unique electronic tag further includes a memory unit configured to store the unique identifier, an RFID transponder configured to receive a radio-wave from the at least one moveable base station and to transmit a radio-wave to the at least one moveable base station reader, and a processor configured to process a query from the at least one moveable base station and to control the transmission of the unique identifier to the at least one moveable base station.

According to still yet another feature, the at least one moveable base station further includes a memory unit, a ranging processor configured to calculate a round-trip air time between sending a signal request from the RFID reader to the unique electronic tag and receiving a response signal from the unique electronic tag in the RFID reader, wherein the RFID reader decodes the unique identifier received from the unique electronic tag, a message reporting processor coupled to the navigation unit, the RFID reader, and the ranging processor, the message reporting processor configured to process information to be reported to the command post. Additionally, the ranging processor is further configured to register a first navigation time from the navigation unit, send a request to the RFID reader for acquiring the unique identifier, receive the unique identifier from the RFID reader, register a second navigation time from the navigation unit, calculate the round-trip air time by subtracting the first navigation time from the second navigation time, and provide, to the message reporting processor, the second navigation time, the received unique identifier, and the calculated round-trip air time, and the message reporting processor is further configured to generate a base station reporting message for output via the second antenna. Furthermore, the base station reporting message includes a current system time, an identification of a corresponding one of the at least one movable base station, a current location of the corresponding one of the at least one movable base station, the received unique identifier, and the calculated round-trip air time.

According to another feature, the base station message database comprises at least one data record for each message received from the at least one moveable base station via the command post transceiver, each of the at least one data records includes a time a message was reported, an identification of a corresponding one of the at least one moveable base station, a location of a the one of the at least one moveable base station, the unique electronic identifier, and a round-trip air time.

According to yet another feature the responder data record associated with the responder location database includes a time when the responder data record was created, the unique identifier, a name of the responder associated with the unique electronic identifier, and the location of the responder.

According to still yet another feature the unique electronic tag is further configured to connect to an equipment sensor associated with external equipment and to store a status of the external equipment in the memory unit.

According to another feature the unique electronic tag is further configured to connect to a physical condition sensor associated with physical condition equipment and to store a status of a responder's physical condition in response to status received from the physical condition sensor.

According to another embodiment, a method of determining a position of a responder is presented. The method includes receiving, at a moveable base station, a unique identifier from an electronic device attached to the responder in response to an identifier request message transmitted from the moveable base station, receiving, at a command post, a base station message from the moveable base station in response to a request for the base station message transmitted from the command post, the base station message, storing, at the command post, the received base station message in a base station message database, calculating, at the command post, the position of the responder using information from at least one stored based station message, and displaying the position of the responder on a map, wherein the base station message comprises the unique identifier, an identifier of the moveable base station, a location of the moveable base station acquired form a navigation unit attached to the moveable base station, and round-trip air time data calculated by determining a difference from a first time of sending the identifier request message from the moveable base station and a second time of receiving the unique identifier at the moveable base station.

According to yet another embodiment, a moveable base station for determining a position of a responder is presented. The moveable base station includes a first transceiver configured to transmit an identifier request message to an electronic device attached to the responder and receiving a response to the identifier request message comprising a unique identifier from the electronic device, a navigation unit configured to acquire a position of the moveable base station, a decoding unit configured to decode the received response to the identifier request message and to extract the unique identifier, a message processor configured to calculate a round-trip air time by subtracting a first time when the identifier request message was transmitted and a second time when the response to the identifier request was received, and a second transceiver for receiving a base station message request from a command post and transmitting a base station message in response to the received base station message request, wherein the base station message comprises the unique identifier, an identifier of the moveable base station, the acquired position of the moveable base station, and the calculated round-trip air time data.

These and other embodiments will also become readily apparent to those skilled in the art from the following detailed description of the embodiments having reference to the attached figures, the invention not being limited to any particular embodiment disclosed.

### BRIEF DESCRIPTION OF THE DRAWINGS

The above and other aspects, features, and advantages of the present invention will become more apparent upon consideration of the following description of preferred embodiments, taken in conjunction with the accompanying drawing figures.

FIGS. 1A and 1B illustrate a system configured with a rapid reference point launch subsystem according to an embodiment of the present invention.

FIGS. 2A and 2B illustrate a rapid reference point launch subsystem according to an embodiment of the present invention.

FIG. 3 illustrates a data record in a reference point message database of a command post subsystem according to an embodiment of the present invention.

FIG. 4 illustrates a personal electronic identifier tag according to an embodiment of the present invention.

FIGS. 5A-5C illustrate a general purpose computer for a command post subsystem according to an embodiment of the present invention.

FIGS. 6A and 6B illustrate a sequence for system startup and initialization prior to arriving at an incident scene according to an embodiment of the present invention.

### DETAILED DESCRIPTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

According to one embodiment, the present invention provides a position tracking system for a team of Responders. Each Responder is equipped with a Radio Frequency Identification (RFID) tag providing a unique electronic identifier to a reference point unit subsystem which is positioned near and around an incident scene. The reference point unit (RPU) subsystem is designed to deploy an RPU. Furthermore, a command post subsystem is deployed at a command post.

Although one RPU subsystem may be deployed to track a Responder with an RFID Tag, in order to triangulate a position of a Responder, at least two RPU subsystems should be deployed. In many configurations, the accuracy of the triangulation is increased as more RPUs are deployed.

Each RPU comprises a RFID reader, a processor capable of measuring round-trip air time between the RFID reader's request and arrival of the Responder's RFID Tag data, a navigation device for determining the current location of the RPU, and a communications link. The communications link may be wired or wireless. The wireless communication may be conducted via a private wireless network or commercially available wireless technology. The commercially available wireless technology may be, for example, WCDMA, UMTS, or satellite-based technology. Additionally, the navigation device may be any device which tracks the position of the RPU, such as a GPS unit.

The RPUs may be numbered with a unique ID. Within each of the RPUs, the RFID reader acquires unique electronic identifier data of a Responder's personnel RFID Tag and the processor measures the round-trip air time of the acquired RFID Tags. Each time RFID Tag data is acquired, a time-stamped message containing the RPU ID, the RPU's current position, the acquired RFID data, and the round-trip air time is reported to the command post subsystem via the communications link.

The command post subsystem is a general purpose computer comprising a memory, a RFID Tag position processor, a physical condition monitoring processor, a three-dimensional (3D) RFID Tag position map processor, and a communications link. The command post subsystem may be designed to withstand the wear from environmental and physical elements which are present at the scene of an incident. The communications link continuously processes messages received from RPUs and registers the messages as a data record in a reference point message database.

The RFID Tag position processor triangulates the current position of each RFID Tag by using the stored data records in the reference point message database. The determined RFID Tag location is registered back to a data record in a RFID Tag position record database.

The 3D RFID Tag position map processor creates a 3D map of the incident scene and displays the 3D map on the user interface. The 3D RFID Tag position map is updated via the most recent data records from the RFID Tag Position Database in order to display the most current position of each Responder. The 3D RFID Tag position map provides real time information regarding the location of each Responder in relation to the 3D incident scene.

The RFID Tag worn by each Responder may also be connected to an equipment sensor and a physical condition sensor. The RFID Tags are configured with equipment presence fields associated with equipment sensors and physical condition data fields associated with physical condition sensors. The data in the equipment presence fields and physical condition data fields are acquired, reported, and registered in the data record of the reference point message database of the command post subsystem.

When the personnel RFID Tag position processor is processing a message record, a warning message is provided to the 3D RFID Tag map processor in the absence of equipment presence data. In other words, the RFID Tag can detect when a piece of equipment, such as a helmet or a fire axe, having an equipment sensor, is no longer within a vicinity of the Responder. The personnel physical condition monitoring processor of the command post subsystem continuously analyzes the physical condition data from the record in the database to determine if the data is in accordance with preset physical condition thresholds, and provides a warning to the 3D RFID Tag map processor when an out-of-threshold physical condition data is detected.

In many configurations, a basic RFID system comprises three components: (1) an antenna or inductive coil, (2) a transceiver with a decoder, and (3) an RFID Tag. An RFID Tag can also be electrically connected to other devices to acquire additional data. The transceivers emit radio signals, via antennas, to activate RFID Tags. The transceivers can both read data from the RFID Tag or write data to the RFID Tag. Often, antennas are packaged with the transceiver and decoder to create an RFID interrogator, also known as an RFID reader.

RFID systems may also include a memory unit and a processor. The RFID Tag can be identified as active or passive depending on the means by which they obtain power. Passive RFID Tags operate without an internal battery source and derive their power from the energy transmitted by the RFID reader. Active RFID Tags utilize a power source, such as an internal battery, and therefore reduce the power requirements of the RFID reader.

Active RFID Tags can provide greater communication range and better noise immunity in comparison to passive RFID Tags. Active RFID Tags can also result in higher data transmission rates when used at higher radio frequencies. When used in a rapid response deployment scenario, an active RFID Tag only requires a minimal power source due to the short duration of the use of the RFID Tag. Therefore, the RFID system can be made reasonably small and lightweight, which is ideal for Responders to carry.

RFID readers emit radio waves with an effective range of approximately one inch to one thousand feet depending on the RFID reader's power output and the radio frequency. When an RFID Tag is in an RFID reader zone, the RFID Tag may detect the RF activation signal sent from the RFID reader and this causes the RFID Tag to transmit its data. The RFID reader receives and decodes the data with the decoded data is provided to a host computer for processing.

In the Responder team operation context, preprogrammed RFID Tags may be carried by Responders for unique identification in the tracking system. An RFID reader may be integrated with a navigation device and a communication link in an RPU. The triangulation position solution, which requires high processing power, is configured to be located in the command post subsystem such that the size and weight of an RPU is kept to a minimum for rapid transport and deployment. However, the triangulation position solution is not limited to being located in the command post subsystem and may be located within a reference point or other structure as needed.

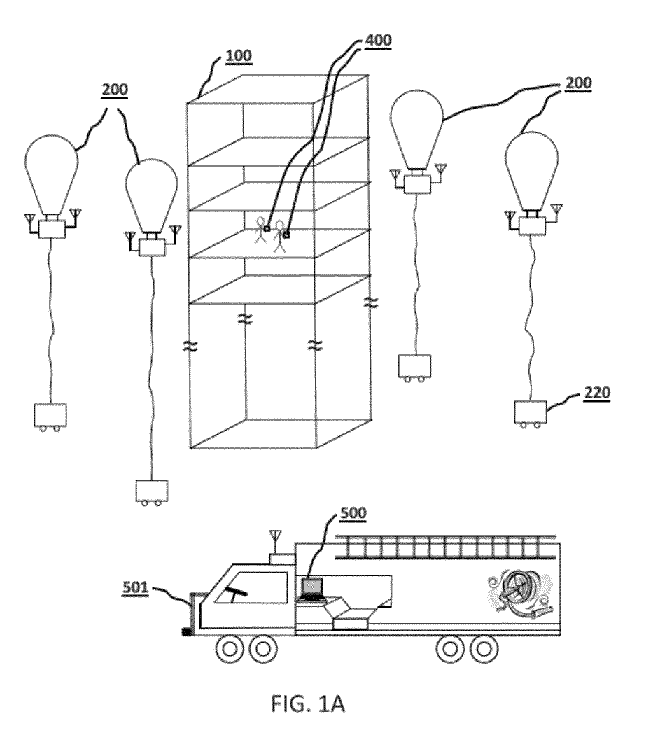

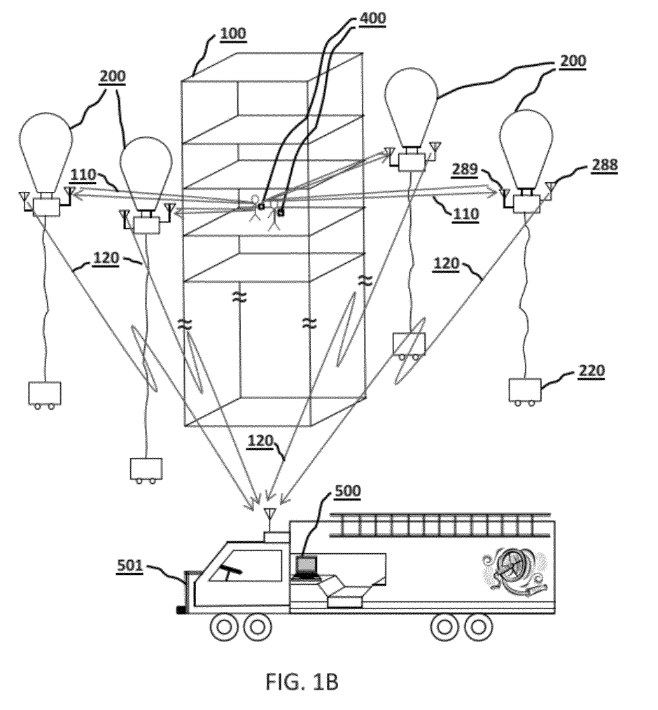

FIG. 1A illustrates a tracking system configured with a reference point launch subsystem according to an embodiment of the present invention. As illustrated in FIG. 1, Responders may be deployed on a floor of a building 100. For example, the Responders may be located on the thirtieth floor of a seventy-story building.

Each Responder may be equipped with a RFID Tag 400. Furthermore, as illustrated in FIG. 1, four Reference Point Subsystems 200 may be deployed from a Storage Cart 220 and a Command Post Subsystem 500 may be deployed within a vehicle 501. The system is not limited to four Reference Point Subsystems 200 and the single Command Post Subsystem 500, as illustrated in FIG. 1, nor is the Command Post Subsystem 500 limited to being disposed within the vehicle 501.

As illustrated in FIG. 1B, various wireless communications signal paths may exist within the tracking system. For example, a first signal path 110 may be established between a RFID Tag 400 and each of the Reference Point Subsystems 200. Additionally, a second signal path 120 may be established between each of Reference Point Subsystems 200 and the Command Post Subsystems 500. The communication link between each of the Reference Point Subsystems 200 and the Command Post Subsystem 500 may be wired or wireless.

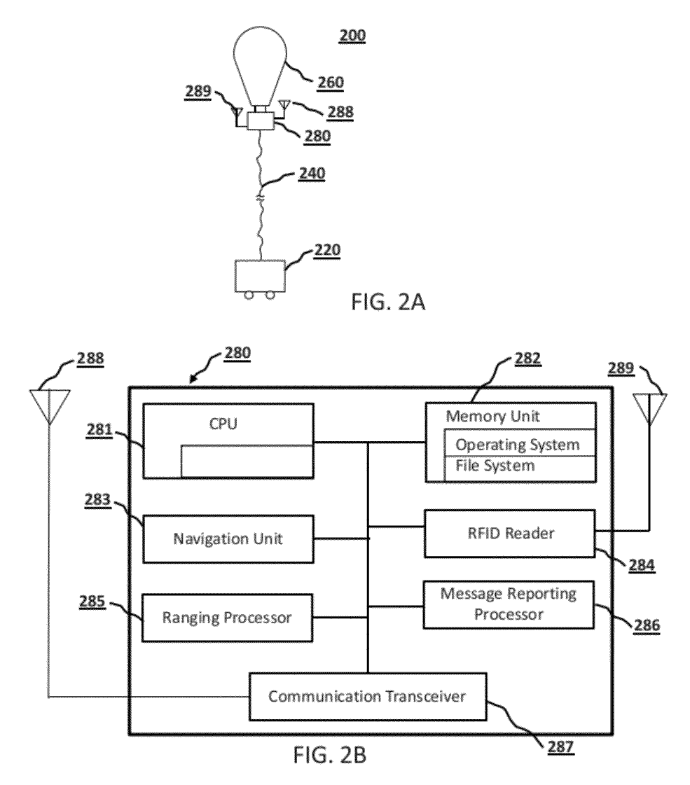

FIG. 2A illustrates a Reference Point Subsystem 200 according to an embodiment of the present invention. As illustrated in FIG. 2, a Reference Point Subsystem 200 comprises an Inflatable Bladder 260, an RPU 280, a Cord 240, and a Storage Cart 220.

When not in use, the Inflatable Bladder 260, the RPU 280, and the Cord 240 of the Reference Point Subsystem 200 are stored in the Storage Cart 220. When stored in the Storage Cart 220, the Inflatable Bladder 260 is not inflated to provide additional space for the RPU 280 and the Cord 240. The Storage Cart 220 can be moved, via attached wheels, and anchored at a desired deployment location at an incident scene. Additionally, the Storage Cart 220 may be designed to withstand the environmental and physical elements which are present at an incident scene, such as a fire.

Furthermore, the Storage Cart 220 may include a power supply unit (not shown) to supply power to the RPU 280, a tank comprising a compressed gas, such as a compressed hydrogen tank (not shown), to inflate the Inflatable Bladder 260, or other equipment. The power supply unit may supply power to the RPU 280 via the Cord 240 or another means. The power supply unit may be stored in the RPU 280, or the RPU 280 may include a backup power supply unit (not shown) in addition to the power supply unit located in the Storage Cart 220.

When inflated, the Inflatable Bladder 260 may lift itself and the RPU 280 to a desired vertical height. The height is controlled by the length of the Cord 240. The length of the Cord 240 is not limited to a certain length and may be of any length required to place the Inflatable Bladder 260 and the RPU 280 at a desired height. The Inflatable Bladder 260 may be inflated by a hydrogen tank (not shown) located in the Storage Cart 220, an external hydrogen tank (not shown), or by any other means which would case the Inflatable Bladder 260 to inflate and rise.

The amount of the Cord 240 released may be manually or electronically controlled by the operator of the Storage Cart 220. Additionally, the Inflatable Bladder 260 may be designed to withstand the environmental and physical elements which are present at an incident scene, such as a fire.

Furthermore, the Reference Point Subsystem 200 may be deployed and controlled from a remote location via a wireless communication link (not shown). For example, at a fire scene, the environmental conditions may not be suitable for a human operator to accompany the Storage Cart 220 to a desired location, therefore, the Storage Cart 220 may be electronically guided to a desired location to automatically deploy the Inflatable Bladder 260 and the RPU 280.

FIG. 2B illustrates a configuration of a RPU 280 according to an embodiment of the present invention. As illustrated in FIG. 2B, the RPU 280 may include at least one central processing unit (CPU) 281, a Memory Unit 282, a Navigation Unit 283, an RFID Reader 284, a Ranging Processor 285, a Message Reporting Processor 286, a Communication Transceiver 287, a First Antenna 288 connected to the Communication Transceiver 287, a Second Antenna 289 connected to the RFID Reader 284, and a Third Antenna (not shown) connected to the Navigation Unit 283.

The RPU 280 may be designed of a rugged material to withstand the environmental and physical elements which are present at an incident scene, such as a fire. However, the RPU should be lightweight such that the RPU 280 may be lifted via the Inflatable Bladder 260. Furthermore, if the RPU 280 is detached from the Inflatable Bladder 260, or if the Inflatable Bladder 260 deflates while in the air, the RPU may survive the impact of a fall and continue functioning in the tracking system.

The First Antenna 288, Second Antenna 289, and Third Antenna may operate to send signals via similar or different channels. For example, the frequency and channel used for signals sent and received via the First Antenna 288 may differ from the frequency and channel used for signals sent and received via the Second Antenna 289.

The RFID Reader 284 may control the output of RFID Tag queries via the Second Antenna 289, receive the response to the RFID Tag query via the Second Antenna, decode the received response to the RFID Tag query into RFID Tag data, and provide the decoded RFID Tag data to another component. The RFID Tag queries may be generated at predetermined time intervals or in response to a signal from a Command Post Subsystem 500.

The Ranging Processor 285 may send a request for RFID Tag data to the RFID Reader 284, register the time of sending the request, wait for a response from the RFID Reader, receive the RFID Tag data from the RFID Reader, register the time of receiving the response, store the received RFID Tag data along with the measured round-trip air time in the memory unit 282, and notify the Message Reporting Processor 286 of the received RFID Tag data. The time between sending the request for and receiving the RFID Tag data is referred to as the round-trip air time.

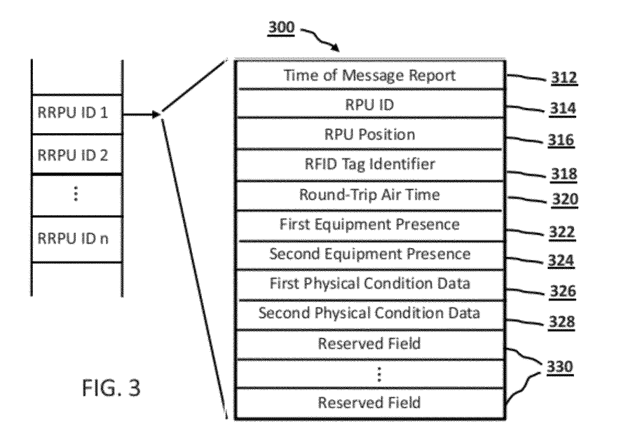

The Navigation Unit 283 may continuously receive location signals, such as a GPS signal, compute its position, and register a time-tagged position in the memory unit 282. Upon receipt of notification from the Ranging Processor 285, the Message Reporting Processor 286 retrieves RFID Tag data, round-trip air time and the most recent tracking position from the memory unit 282, formulates a Reporting Message 300 (FIG. 3), and transmits the Reporting Message to the Command Post Subsystem 500 via a Communication Transceiver 287 and the First Antenna 288.

The RPU 280 is not limited to the structures illustrated in FIG. 2B and may include additional components which have not been illustrated. Additionally, the RPU 280 is not limited to including the First Antenna 288 and the Second Antenna 289 and additional antennae may be utilized as needed.

FIG. 3 illustrates an RPU Reporting Message 300 according to an embodiment of the present invention. As illustrated in FIG. 3, the RPU Reporting Message 300 includes a Time of Message Report 312, an RPU ID 314, an RPU Position 316, an RFID Tag Identifier 318, a Round-Trip Air Time 320, a First Equipment Presence 322, a Second Equipment Presence 324, a First Physical Condition Data 326, a Second Physical Condition Data 328, and at least one Reserved Field 330.

The Time of Message Report 312 provides a time stamp for the RPU Reporting Message 300. The RPU ID 314 provides an ID for the RPU 280, such that each RPU has a unique ID. The RPU Position 316 provides the coordinates of the RPU 280 which were acquired by the Navigation Unit 283. The RFID Tag Identifier 318 provides the ID for the queried RFID Tag 400, with each RFID Tag having a unique ID. The Round-Trip Air Time 320 is the calculated time between sending the request for RFID Tag data and receiving the RFID Tag data. The First Equipment Presence 322 and the Second Equipment Presence 324 provide the status of a piece of equipment attached to an equipment sensor. The First Physical Condition Data 326 and Second Physical Condition Data 328 provide status from various physical condition sensors which may be present on the Responder. The Reserved Field 330 may be reserved for future use or may include additional Equipment Presence or Physical Condition Data fields. Additionally, the RPU Reporting Message 300 is not limited to the aforementioned fields and may include more or less fields as necessary.

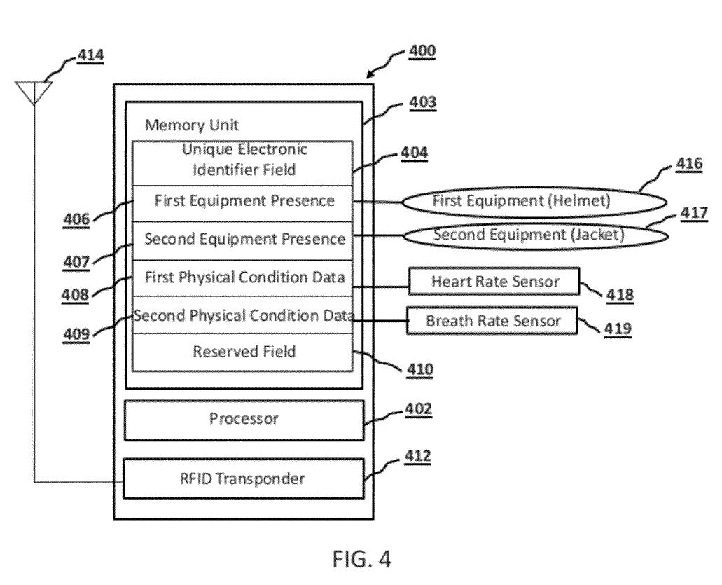

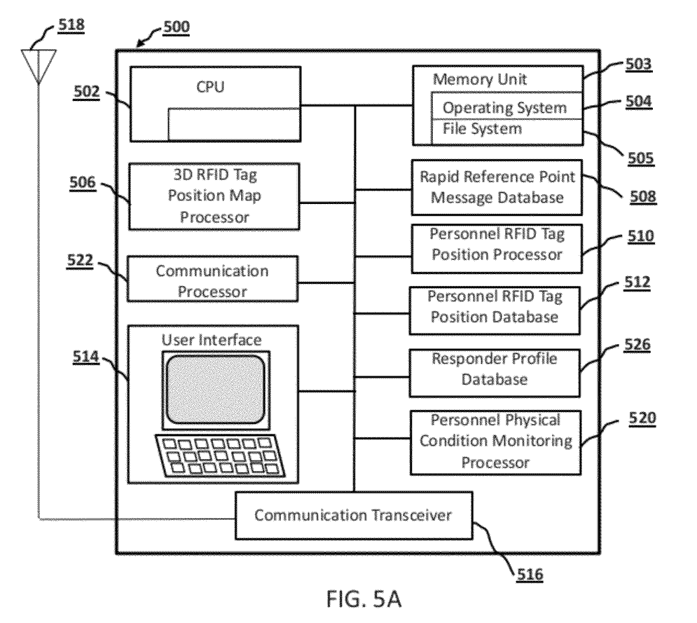

FIG. 4 illustrates an RFID Tag 400 according to an embodiment of the present invention. As illustrated in FIG. 4 the RFID Tag 400 may include a Processor 402, a Memory Unit 403, an RFID transponder 412, and a Transponder Antenna 414. The Memory Unit 403 may include a pre-programmed Unique Electronic Identifier Field 404, First Equipment Presence 406, Second Equipment Presence 407, First Physical Condition Data 408, Second Physical Condition Data 409, and at least one Reserved Field 410.

The First Equipment Presence 406 and Second Equipment Presence 407 may be registered with a first value, such as a positive value, when electronically connected to external equipment such as a Helmet 416 or a Jacket 417. A second value, such as a negative value, in First Equipment Presence 406 or Second Equipment Presence 407 signifies the absence of the external equipment. The First Physical Condition Data 408 or Second Physical Condition Data 409 may be electronically connected to a Physical Condition Sensor such as a Heart Rate Sensor 418 or a Breathe Rate Sensor 419. The values in the First Physical Condition Data 408 and Second Physical Condition Data 409 represent the actual measured data from the connected Physical Condition Sensors, such as the Heart Rate Sensor 418 or the Breathe Rate Sensor 419. The Reserved Field 410 is for possible future expansion of functions.

The Processor 402 receives a query, via the Communication Transponder 412 and the Antenna 414, sent from an RFID Reader 284 (FIG. 2B). In response to the query, the Processor 402 retrieves the data from the Memory Unit 403 and controls the transmission of the response to the query from the RFID Reader 284 via the Communication Transponder 412 and the Antenna 414.

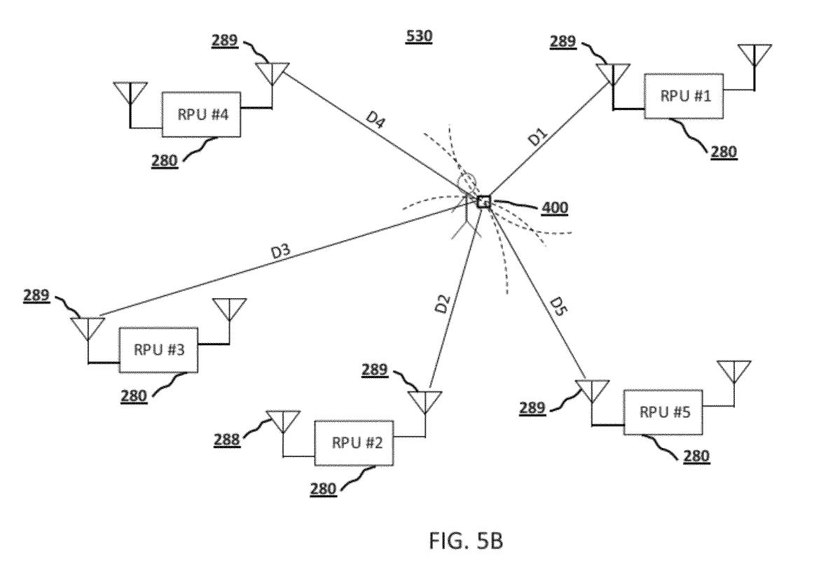

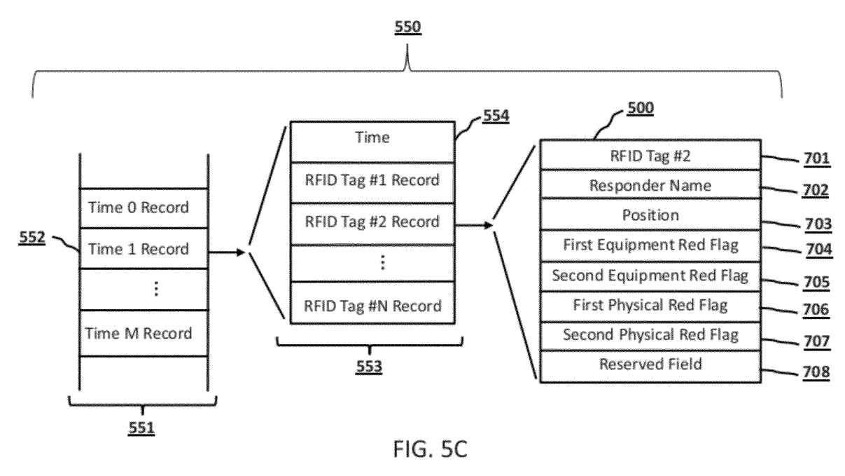

FIG. 5A illustrates a general purpose computer for a command post subsystem 500 according to an embodiment of the present invention. As illustrated in FIG. 5 the Command Post Subsystem 500 may include at least one Central Processing Unit (CPU) 502, a Memory Unit 503, a Communication Processor 522, a RFID Tag Position Processor 510, a Physical Condition Monitoring Processor 520, a 3D RFID Tag Map Processor 506, a User Interface 514 including a display unit, a Communication Transceiver 516, and an Antenna 518.

The Memory Unit 503 may store an Operating System 504, a File System 505, and databases such as a Reference Point Message Database 508, a RFID Tag Position Database 512, and a Responder Profile Database 526. As illustrated in FIG. 5, the Reference Point Message Database 508, the RFID Tag Position Database 512, and the Responder Profile Database 526 are distinct from the Memory Unit 503. However, as previously stated, the aforementioned databases may be located in the Memory Unit 503.

The RPU Reporting Message 300 (FIG. 3) is an example of a data record which may be stored in the Reference Point Message Database 508. Additionally, the RFID Tag Position Record 550 (FIG. 5C) is an example of a data record which may be stored in the Personnel RFID Tag Position Database 512. The Responder Profile Database 526 may store records for each Responder and the associated RFID Tag and may store additional information regarding each Responder.

During initialization of the Command Post Subsystem 500, the 3D RFID Tag Position Map Processor 506 is provided with the map of the incident area, such as the blueprints of the building 100 (FIG. 1). The map of the incident area may be pre-stored in a memory unit or may be downloaded as needed via the Internet, an Intranet, or a user interface. The 3D RFID Tag Position Map Processor 506 then creates a 3D Scenario Map of the given incident scenario for further use.

The Communication Processor 522 processes data received from the RPUs 280 via the Antenna 518 and the Communication Transceiver 516. For example, the Communication Processor 522 receives incoming RPU Reporting Messages 300 from all RPUs 280 and registers the received Reporting Messages 300 in the Reference Point Message Database 508 which may be stored in the Memory Unit 503. The Reference Point Message Database 508 may also be stored in a distinct memory unit (not shown). The Communication Processor 522 receives data from the RPUs 280 in response to message requests sent from the Command Post Subsystem 500 at a predetermined interval or at the request of an operator.

Alternatively, according to another embodiment, the RPUs 280 may independently send data to the Command Post Subsystem 500 such that the data is not sent in response to a message request sent from the Command Post Subsystem. In this example, the RPUs 280 may send the data to the Command Post Subsystem 500 at a predetermined interval or as the data is received from an RFID Tag 400 of a Responder.

The RFID Tag Position Processor 510 queries the Reference Point Message Database 508 until the RFID Tag Position Processor receives a predetermined number of unique RPU Reporting Messages 300 associated with the same RFID Tag Identifier and having a Time of Message Report 312 within a specific time period (FIG. 3). Specifically, each of the RPU Reporting Messages 300 are received from a unique RPU 280. When the predetermined number of Message Records 300 is received, the RFID Tag Position Processor 510 determines the position of the RFID Tag 400 via a triangulation algorithm, and thereby determines the position of the Responder since the RFID Tag 400 is attached to the Responder.

Specifically, the triangulation algorithm uses the data from the RPU Reporting Message 300, such as the RPU ID 314, the RPU Position 316, and the Round-Trip Air Time 320, to determine the position of the Responder. More specifically, the RFID Tag Position Processor 510 first converts the Round-Trip Air Time to a distance, such as feet or meters, and then executes a triangulation algorithm as illustrated in FIG. 5B. While determining the location of the Responder via triangulation, the RFID Tag Position Processor 510 may simultaneously determine the values of the First Equipment Presence 322 and the Second Equipment presence 324 of the RPU Reporting Message 300.

Specifically, as illustrated in FIG. 5B, the triangulation algorithm may acquire five distinct distances D1-D5 from an RFID Tag 400 to the respective RPUs 280. As mentioned above, the RFID Tag Position Processor 510 first converts the Round-Trip Air Time 320 to a distance, such as feet or meters. Once the distances between the RPUs 280 and the RFID Tag 400 are determined, the RFID Tag Position Processor 510 may determine the location of the RFID Tag 400 via the triangulation algorithm.

When the triangulation algorithm is complete, the location of the Responder is determined and the Communication Processor 522 stores the location associated with the RFID Tag 400 in an RFID Tag Position Record 550 in the RFID Tag Position Database 512. Additionally, if either of the First Equipment Presence 322 or the Second Equipment Presence 324 fields are set with a value indicating an error, an Equipment Red Flag field of the RFID Tag Position Record 550 in the RFID Tag Position Database 512 is registered with a value to indicate an error, such as a negative value.

The Physical Condition Monitoring Processor 520 continuously queries new data records from the Reference Point Message Database 508 and compares the values of the First Physical Condition Data 326 and Second Physical Condition Data 328 to predefined thresholds. When the Physical Condition Monitoring Processor 520 detects out-of-threshold First or Second Physical Condition Data, a respective Physical Red Flag field is set to a first value in a respective RFID Tag Position Record 550 in the RFID Tag Position Database 512.

The 3D RFID Tag Position Map Processor 506 queries RFID Tag Position Records 550 from the RFID Tag Position Records Database 512, creates a 3D RFID Tag Position Map for each new record, overlays the 3D RFID Tag Position Map (not shown) with the 3D Scenario Map (not shown), and display the 3D Position Map on the User Interface 514.

FIG. 5C illustrates an example of RFID Tag Position Records 550 stored in the RFID Tag Position Database 512. The first level of the RFID Tag Position Database 512 includes Time Records 551 sorted according to time. Time Records 551 may be stored according to a predetermined interval or may be stored as each new record is created. For example, as illustrated in FIG. 5C, the Time 1 Record 552 may have been created at a predetermined time interval when the RFID Tag Position Processor 510 queried the Reference Point Message Database 508 or when the RFID Tag Position Processor created the RFID Tag Position Record 550 after querying the Reference Point Message Database 508.

Each Time Record 551 comprises records, such as RFID Tag Records 553, for each unique RFID which was queried during a time period represented by the Time Record entry 554 stored in the respective Time Record 551. For example, Time 1 Record 552 includes a Time Record entry 554 associated with when the Time 1 Record and also includes RFID Tag Records 553 for all the data acquired for each RFID Tag 400.

Each RFID Tag Record 553 includes information associated with the respective RFID Tag 400 at the time of the Time Record entry 554. Specifically, The RFID Tag Record 553 includes an RFID Tag Number 701, a Responder Name 702, a Position 703, a First Equipment Red Flag 704, a Second Equipment Red Flag 705, a First Physical Red Flag 706, a Second Physical Red Flag 707, and a Reserved Field 708.

The RFID Tag Number 701 is a unique number associated with the RFID Tag. The Responder Name 702 is the name of the Responder who is associated with the RFID Tag. The Position 703 is the location of the RFID Tag at the time of the Time Record 554. The Equipment Red Flag 1 704 and the Equipment Red Flag 2 705 indicate whether a piece of equipment is present or missing. The Physical Red Flag 1 706 and the Physical Red Flag 2 707 indicate whether a physical condition is within or beyond a predetermined physical condition threshold. Finally, the Reserved Field 708 is reserved for future use.

The aforementioned fields of the databases and records, such as the RFID Tag Position Database 512 and the RFID Tag Position Record 500, are not limited to the previously discussed. The fields of the database and records may include more or less fields as necessary.

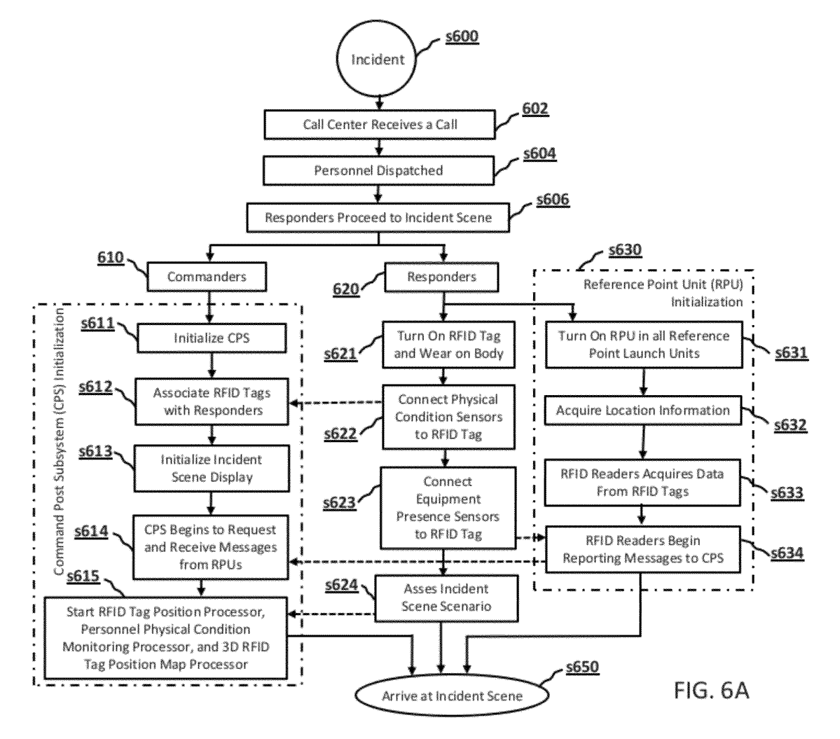

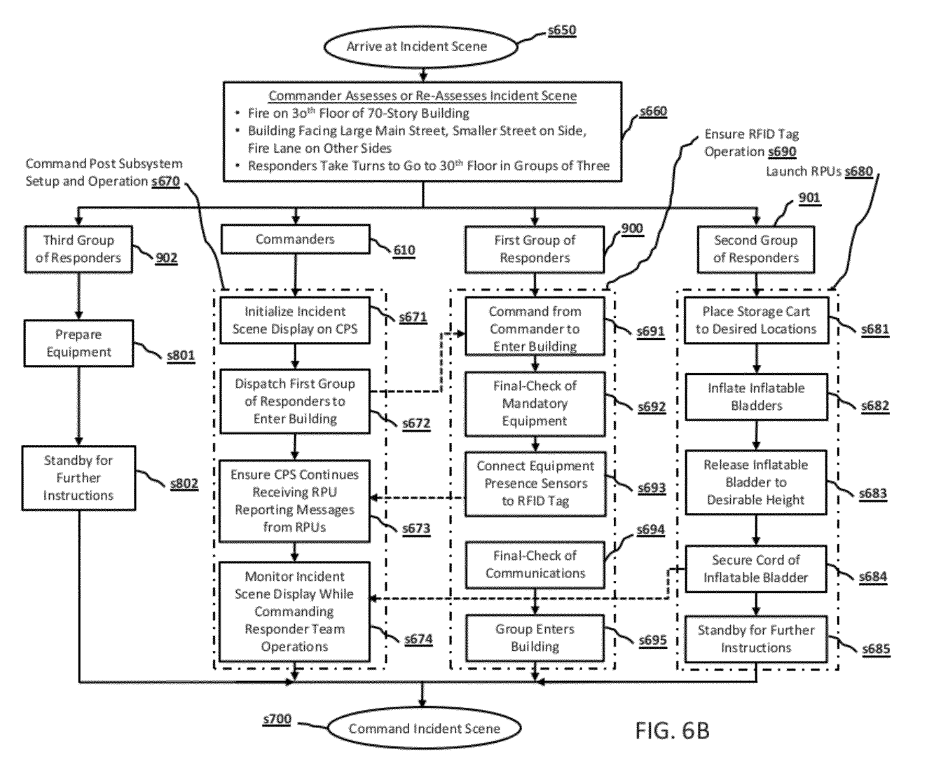

FIG. 6A illustrates the sequence of system startup and initialization prior to arriving at an incident scene according to an embodiment of the present invention. Responders are generally stationed in a Responder Station, such as a Fire House, a Hospital, or a Police Station.

When an incident (s600), such as a fire, occurs, a call center receives a report call (s602). The call center may be a 911 center or any other emergency dispatch center. For the purposes of this example, the reported incident will be a fire in a high rise building. However, the incident is not limited to a fire, and the Responders are not limited to Fire Fighters.

After receiving a call, the call center dispatches the appropriate Personnel (s604) and the Personnel proceed to the incident scene (s606). The Personnel are divided into Commanders 610 and Responders 620. Each incident (s600) includes at least one Responder and at least one Commander. However, the at least one Commander is not limited to being located at the scene of the incident (s600).

Prior to arriving at the incident, the Responders 620 initialize the multiple RPUs (s630) and turn on an RFID Tag 400 associated with each Responder 620 (s621). The RFID Tag 400 may be worn on the body of the Responder 620, such as on the wrist, waist, or any other location. Once the RFID Tag 400 is activated, the Responder 620 may connect the Physical Condition Sensors (s622) and the Equipment Presence Sensors (s623) to the RFID Tag. The connection with the Physical Condition Sensors and the Equipment Presence Sensors may be wired or wireless, such as a Bluetooth™ connection. Finally, the Responders assess the incident scenario as reported by the dispatch or Commander (s624).

When the RPU 280 is initialized (s630), the RPU 280 is turned on (s631), the navigation unit 283 begins acquiring the location information (s632), and the RFID Reader acquires the data from the RFID Tags 400 of the Responders 620 (s633). Finally, the RPU 280 begins reporting messages to the Command Post Subsystem 500 (s634).

Furthermore, prior to the Responders 620 arriving to the incident, the Commanders 610 initialize the Command Post Subsystem (CPS) (s611) and associates the RFID Tags 400 with the Responders 620 (s612). The association of the RFID Tags 400 with the Responders 620 may be predetermined or the information may be communicated to the Commanders 610 once the Responders 620 have activated the respective RFID Tags.

The Commanders 610 then initialize the incident scene display (s613) and the Command Post Subsystem 500 begins requesting and receiving messages from the RPUs (s614). Once the messages are received from the RPU 280, the messages are stored in the appropriate databases and the 3D position map may be generated. In this example, since the Responders 620 are still on the way to the incident, the 3D position map may display the location of the Responders in route to the incident.

The steps illustrated in FIG. 6A may be initiated prior to the Responders 620 arriving at the incident scene, however, it is not required for all of the steps to be complete before the Responders 620 arrive at the scene (s650). Additionally, the process illustrated in FIG. 6A may be initialized prior to receiving an incident call (s620) or when the Responders 620 arrive at a scene (s650).

FIG. 6B illustrates a process when the Responders arrive at an incident according to an embodiment of the invention. After the Responders arrive at the incident scene (s650), the Commanders 610 assess or re-assess the incident scene (s660).

In this example, the incident is a fire on the 30^{th} floor of a 70-story building. The building faces a large street, with a smaller street on a side, and fire lanes on the remaining sides. The Commander 610 may determine that the Responders should take turns in groups of three to go to the 30^{th} floor to combat the fire.

While commanding the operation, the commander ensures the proper operation of the CPS 500 and begins monitoring all resources using the information displayed on the CPS (s670). When at the incident scene, the Commanders 610 initialize the incident scene display on the CPS 500 (s671).

The initialization includes loading a blueprint of the structure involved in the incident. For example, the Commanders 610 may load a map of the surrounding street and structures and a blueprint of the 70-story building.

Once the display is initialized, the Commanders 610 may command a First Group of Responders 900 to enter the building (s672). The Commanders 610 then ensures that the CPS 500 continues to receive RPU Reporting Messages 300 from the RPUs (s673) and monitors the incident display while commanding team operations (s674).

Prior to the Commanders 610 dispatching the First Group of Responders 900 to enter the building (s672), the First Group of Responders 900 ensure operation of the RFID Tags (s690), the Second Group of Responders 901 launch the RPUs (s680), and the Third Group of Responders 902 provide additional support. It is often useful for groups of Responders 620 to perform various tasks. However, the process of initializing the RFID Tags 400 and launching the RPUs 280 is not limited to the process illustrated in FIG. 6B.

In ensuring the operation of the RFID Tags 400, the First Group of Responders 900 will receive a command to enter the building (s691) and proceed to check that each Responder 620 has the mandatory equipment (s692). Once it is verified that each Responder has the mandatory equipment (s692), the equipment presence sensors are connected to the RFID Tag 400 (s693) and a final check on all communications is performed (s694). The group then proceeds to enter the building (s695).

In launching the RPUs 280 (s680), the Second Group of Responders 901 must first place the Storage Carts 220 in the desired locations (s681). It is often useful for the Storage Carts 220 to surround the building. Once the Storage Carts are positioned and anchored, the Inflatable Bladders 260 are inflated (s682) and released to a desired height (s683).

In this example, the desired height would be proximal to the 30^{th} floor since the fire is located on the 30^{th} floor. Once the RPU 280 and the Inflatable Bladders 260 are positioned at the appropriate height, the cord is secured 684 and the Second Group of Responders 901 standby for further instructions (s685).

Meanwhile, the Third Group of Responders 902 may prepare fire hoses or other equipment (s801) and standby for further instructions (s802).

Finally, once the First Group of Responders 900 has entered the building (s695) and the Second Group of Responders 901 have launched the RPUs (s680) the Commanders may command the incident scene (s700)

The process illustrated in FIG. 6B is not limited to the three groups of Responders 620. The number of groups may vary as needed to respond to an incident and deploy the RPUs 280.

While some embodiments of the present invention have been described as utilizing an RFID reader and a RFID Tag system for personnel identification and range measurement, other systems that are capable of accomplishing the same functions would be equally applicable to the present invention. For example, the RFID can be replaced by a system WiFi-based communications system that can provide querying, identification, and range measurement functions.

Similarly, the GPS receiver described in embodiments of the present invention could be replaced by a GPS-enabled cellular phone device. Commercial 3G and 4G mobile communications networks are offer very high data bandwidth. Therefore, a GPS enabled 3G/4G phone may be utilized as a communication link device in an embodiment of the present invention.

Furthermore, an Inflatable Bladder 260 is described in embodiments of the present invention. In the context of the present invention, the Inflatable Bladder only needs to be able to lift a few pounds of electronics devices into the air. Therefore, the Inflatable Bladder 260 can be replaced by any other device or method that can practice the same functional requirements.

While the present invention has been described with reference to a few specific embodiments, the description is illustrative of the method and is not to be construed as limiting the method. Various modifications may occur to those skilled in the art without departing from the true spirit and scope of method as defined by the appended claims.

1. A position tracking system for responders to an emergency, the position tracking system comprising:
a unique electronic tag attached to each responder and comprising a transceiver, the unique electronic tag configured to receive information and transmit a unique identifier via the transceiver;
at least one moveable base station; and
a command post comprising the command post transceiver configured to send and receive information,
wherein the at least one moveable base station comprises:
a first antenna configured to communicate with the transceiver of the unique electronic tag;
a second antenna configured to communicate with the command post transceiver;
a navigation unit for determining a current position of the at least one moveable base station;
a radio-frequency identification (RFID) reader configured to decode information received from the unique electronic tag; and
a processor configured to control the navigation unit and the RFID reader.

2. The position tracking system of claim 1, wherein the at least one moveable base station further comprises:
a housing unit configured to house the first antenna, the second antenna, the navigation unit, the RFID reader, and the processor;
an inflatable bladder attached to the housing unit and configured to inflate and lift the housing unit to a desired height;
a cord attached to the housing unit and configured to adjust the height at which the inflatable bladder is deployed; and
a storage cart configured to store and to transport the housing unit, the inflatable bladder, and the cord to a desired location.

3. The position tracking system of claim 1, wherein the command post further comprises:
a central processing unit;
a memory unit comprising a base station message database and a responder location database;
a location processor configured to determine the location of a responder using information received at the at least one moveable base station and to store the determined location of the responder in a responder data record associated with the responder location database;
a physical condition monitoring processor;
an electronic identifier position map processor for generating a three-dimensional (3D) position map of a responder using the responder data record associated with the responder location database;
a user interface for displaying the 3D position map; and
a communication processor for controlling the receiving and transmitting of messages via the command post transceiver.

4. The position tracking system of claim 1, wherein the unique electronic tag further comprises:
a memory unit configured to store the unique identifier;
an RFID transponder configured to receive a radio-wave from the at least one moveable base station and to transmit a radio-wave to the at least one moveable base station reader; and
a processor configured to process a query from the at least one moveable base station and to control the transmission of the unique identifier to the at least one moveable base station.

5. The position tracking system of claim 2, wherein the at least one moveable base station further comprises:
a memory unit;
a ranging processor configured to calculate a round-trip air time between sending a signal request from the RFID reader to the unique electronic tag and receiving a response signal from the unique electronic tag in the RFID reader,
wherein the RFID reader decodes the unique identifier received from the unique electronic tag;
a message reporting processor coupled to the navigation unit, the RFID reader, and the ranging processor, the message reporting processor configured to process information to be reported to the command post.

6. The position tracking system of claim 5, wherein:
the ranging processor is further configured to
register a first navigation time from the navigation unit,
send a request to the RFID reader for acquiring the unique identifier,
receive the unique identifier from the RFID reader,
register a second navigation time from the navigation unit,
calculate the round-trip air time by subtracting the first navigation time from the second navigation time, and
provide, to the message reporting processor, the second navigation time, the received unique identifier, and the calculated round-trip air time; and
the message reporting processor is further configured to generate a base station reporting message for output via the second antenna.

7. The position tracking system of claim 6, wherein the base station reporting message comprises:
a current system time;
an identification of a corresponding on of the at least one movable base station;
a current location of the corresponding on of the at least one movable base station;
the received unique identifier; and
the calculated round-trip air time.

8. The position tracking system of claim 3, wherein:
the base station message database comprises at least one data record for each message received from the at least one moveable base station via the command post transceiver;
each of the at least one data records comprises:
a time a message was reported;
an identification of a corresponding one of the at least one moveable base station;
a location of a the one of the at least one moveable base station;
the unique electronic identifier; and
a round-trip air time.

9. The position tracking system of claim 3, wherein the responder data record associated with the responder location database comprises:
a time when the responder data record was created;
the unique identifier;
a name of the responder associated with the unique electronic identifier; and
the location of the responder.

10. The position tracking system of claim 4, wherein the unique electronic tag is further configured to connect to an equipment sensor associated with external equipment and to store a status of the external equipment in the memory unit.

11. The position tracking system of claim 4, wherein the unique electronic tag is further configured to connect to a physical condition sensor associated with physical condition equipment and to store a status of a responder's physical condition in response to status received from the physical condition sensor.

12. A method of determining a position of a responder, the method comprising:
receiving, at a moveable base station, a unique identifier from an electronic device attached to the responder in response to an identifier request message transmitted from the moveable base station;
receiving, at a command post, a base station message from the moveable base station in response to a request for the base station message transmitted from the command post, the base station message;
storing, at the command post, the received base station message in a base station message database;
calculating, at the command post, the position of the responder using information from at least one stored based station message; and
displaying the position of the responder on a map,
wherein the base station message comprises:
the unique identifier;
an identifier of the moveable base station;
a location of the moveable base station acquired form a navigation unit attached to the moveable base station; and
round-trip air time data calculated by determining a difference from a first time of sending the identifier request message from the moveable base station and a second time of receiving the unique identifier at the moveable base station.

13. The method of claim 12, further comprising deploying the moveable base station from a moveable storage cart, wherein the moveable base station comprises a housing unit, an inflatable bladder attached to the housing unit, and a cord attached to the moveable storage cart and the housing unit, such that the moveable base station may be deployed to a vertical height when the inflatable bladder is inflated.

14. The method of claim 12, wherein the electronic device comprises an RFID transponder and further comprising the RFID transponder generating a radio-wave in response to receiving the identifier request message including the unique identifier.

15. The method of claim 12, wherein the moveable base station comprises an RFID reader and further comprising the RFID reader generating the identifier request message and decoding the received identifier request message.

16. The method of claim 12, wherein the electronic device is connected to an equipment sensor to obtain an equipment status of external equipment and to a physical condition sensor to obtain a physical condition status of a responder's physical condition and further comprising receiving the equipment status and the physical condition status with the unique identifier in the response to the identifier request message.

17. A moveable base station for determining a position of a responder, the moveable base station comprising:
a first transceiver configured to transmit an identifier request message to an electronic device attached to the responder and receiving a response to the identifier request message comprising a unique identifier from the electronic device;
a navigation unit configured to acquire a position of the moveable base station;
a decoding unit configured to decode the received response to the identifier request message and to extract the unique identifier;
a message processor configured to calculate a round-trip air time by subtracting a first time when the identifier request message was transmitted and a second time when the response to the identifier request was received; and
a second transceiver for receiving a base station message request from a command post and transmitting a base station message in response to the received base station message request,
wherein the base station message comprises:
the unique identifier;
an identifier of the moveable base station;
the acquired position of the moveable base station; and
the calculated round-trip air time data.

18. The moveable base station of claim 17, further comprising:
a housing unit for housing the first transceiver, the navigation unit, the decoding unit, the message processor, and the second transceiver;
a moveable storage cart;
an inflatable bladder attached to the housing unit; and
a cord attached to the moveable storage cart and the housing unit such that the moveable base station may be deployed to a vertical height when the inflatable bladder is inflated,
wherein the housing unit, the inflatable bladder, and the cord are stored in the storage cart.

19. The moveable base station of claim 17, wherein the decoding unit is an RFID reader further configured to generate the identifier request message.
